(19) United States
(12) Patent Application Publication
(10) Pub. No.: US 2024/0209633 A1
(43) Pub. Date: Jun. 27, 2024

(54) METHOD FOR APPLICATION OF PROTECTIVE ROOF COATING

(71) Applicant: Timothy L. Hendershot, Melboume, FL (US)

(72) Inventor: Timothy L. Hendershot, Melboume, FL (US)

(21) Appl. No.: 18/519,438

(22) Filed: Nov. 27, 2023

Related U.S. Application Data
(60) Provisional application No. 63/435,283, filed on Dec. 26, 2022.

(51) Int. Cl. E04D 11/02; B05B 9/08; E04D 1/20; E04D 15/07

(52) U.S. Cl. CPC E04D 11/02; B05B 9/085; E04D 1/20; E04D 15/07

(57) ABSTRACT

The present invention provides a method for providing a protective coating to a roof surface. The method includes the steps of: providing a spraying means and a liquid protective coating, the spraying means being configured to apply the protective coating; operating the spraying means such that the protective coating is applied to the roof surface beginning at a first row; applying the protective coating by performing the following steps; spraying horizontally at the first row; covering the roof surface with the protective coating generally uniformly; completing the first row and continuing to a second row that is below the first row; repeating the applying step such that the second row becomes the first row until the roofing surface is covered; and curing the protective coating for a predetermined period of time.

### BACKGROUND OF THE INVENTION

This invention relates generally to methods for protecting and extending the life of an installed roofing material and, more specifically, to a method for applying a protective roof coating to an asphalt shingle roof.

People have been using a variety of roofing materials to cover buildings for protection from the elements ever since antiquity. Conventional modern roofing systems normally include either asphalt shingles, ceramic materials, or metal. Each has its advantages and disadvantages. All have a useful life that varies one from the other. Unfortunately, each of these materials is subject to wear and thus all deteriorate through time. Asphalt shingles are the most vulnerable to wear and damage because asphalt shingles are thin and soft.

The deterioration is caused by elements like wind, rain, snow, and ice. One of the most damaging forms of weathering is caused by hail impact. Even the ultraviolet light from natural sunlight produces stress and wear over time. Other roof damage comes from changing temperatures such as a continuous freeze and thaw cycle during some months in some climates. Extremes of temperature changes between summer heat and winter cold take a toll on a roof.

One problem associated with conventional asphalt shingles is that the granular protective material adhered to the surface of such shingles gradually wears away.

Another problem associated with conventional asphalt shingles is that they can be damaged by conventional washing techniques such as pressure washing.

Another problem associated with conventional asphalt shingles is that it might be desired to change the color of the roof well within the useful lifetime of the asphalt shingles on the roof.

### BRIEF SUMMARY OF THE INVENTION

These problems are addressed by a method for application of a protective roof coating disclosed herein that helps to alleviate the problem of natural weathering. With proper application techniques, readily available concrete sealants can be utilized to protect new roofs from future damage and give new life to old, deteriorated roofs.

In addition, the disclosed invention seals cracks and the edges of asphalt shingles such that wind cannot get beneath them and blocks damaging ultraviolet light. The disclosed method also seals and bonds the roofing components together thereby protecting them from water seepage and damaging freeze and thaw cycles. When properly applied, the coating seals and prevents cracks and shields the roofing materials from damaging hail impacts and acid rain. The method disclosed provides a variety of application techniques that can be varied to fit a particular need such as the type of sprayer, the nozzles associated with the sprayer, the sealant, etc.

The method disclosed herein is configured to apply a sealant such as a concrete sealer to roofing material such as asphalt shingles. In this manner, the roofing material is mechanically strengthened and protected from UV light. The mechanical strengthening of the roof includes adhering an aggregate surface structure to the underlying asphalt base material, thereby sealing and locking the tiny granules in place. As a result of the granules being secured to the underlying asphalt base material, the roof can be washed using conventional techniques. Thus debris, moss, and algae can be cleaned off of the roof using a technique such as pressure washing. Another feature of the method disclosed herein is that it can provide for color additives so that the appearance of the roof with asphalt shingles thereon can be changed.

According to one aspect of the technology described herein, there is provided a method for providing a protective coating to a roof surface. The method including the steps of: providing a spraying means and a liquid protective coating, the spraying means being configured to apply the protective coating; operating the spraying means such that the protective coating is applied to the roof surface beginning at a first row; applying the protective coating by performing the following steps; spraying the first row; covering the roof surface with the protective coating generally uniformly; completing the first row and continuing to a second row that is adjacent the first row; repeating the applying step such that the second row becomes the first row until the roofing surface is covered; and curing the protective coating for a predetermined period of time.

According to another aspect of the technology disclosed herein, there is provided a method for providing a protective coating to a roof surface. The method including the steps of: A method for providing a protective coating to a roof surface, the method including the steps of: providing a spraying means and a liquid protective coating, the spraying means being an airless low-pressure system being configured to apply the protective coating; operating the spraying means such that the protective coating is applied to the roof surface beginning at a first row that is at the highest point of the roof surface; applying the protective coating by performing the following steps; spraying horizontally at the first row; covering the roof surface with the protective coating generally uniformly; ensuring that the protective coating fully penetrates and covers cracks and crevices; completing the first row and continuing to a second row that is below the first row; repeating the applying step such that the second row becomes the first row until the roofing surface is covered; and curing the protective coating for a predetermined period of time.

According to yet another aspect of the technology disclosed herein, there is provided a method for providing a protective coating to a roof surface. The method including the steps of: providing the roof surface, a spraying means, and a liquid protective coating, the roof surface configured to include a substrate layer, a support layer and a roofing material layer the spraying means being configured to apply the protective coating; operating the spraying means such that the protective coating is applied to the roof surface beginning at a first row; applying the protective coating by performing the following steps; spraying horizontally at the first row; covering the roof surface with the protective coating generally uniformly; completing the first row and continuing to a second row that is below the first row; repeating the applying step such that the second row becomes the first row until the roofing surface is covered; and curing the protective coating for a predetermined period of time.

### BRIEF DESCRIPTION OF THE DRAWINGS

The invention may be best understood by reference to the following description taken in conjunction with the accompanying drawing figures in which:

FIG. 1 is a partially cut away plan view of a roof surface in accordance with the present disclosed technology; and

FIG. 2 is a flow diagram of the method according to the present disclosed technology.

### DETAILED DESCRIPTION OF THE INVENTION

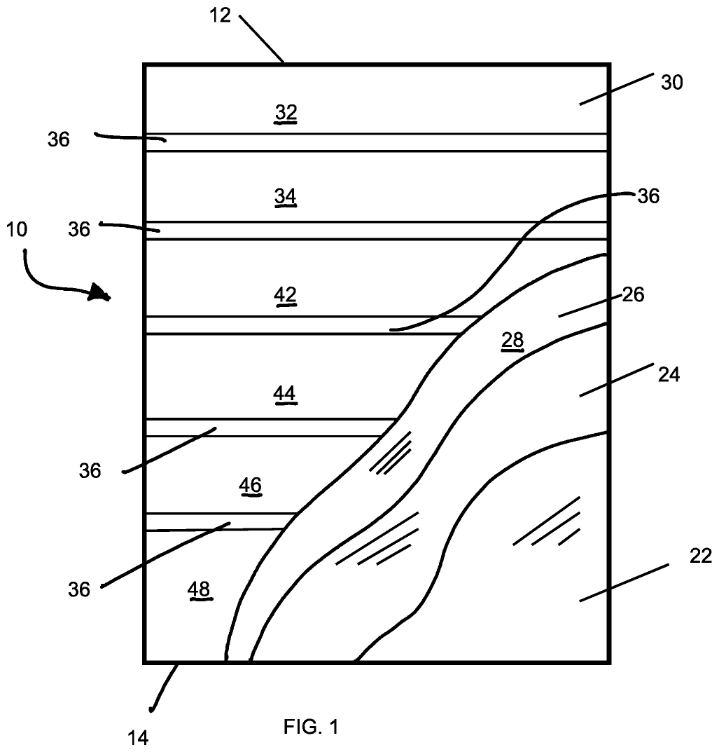

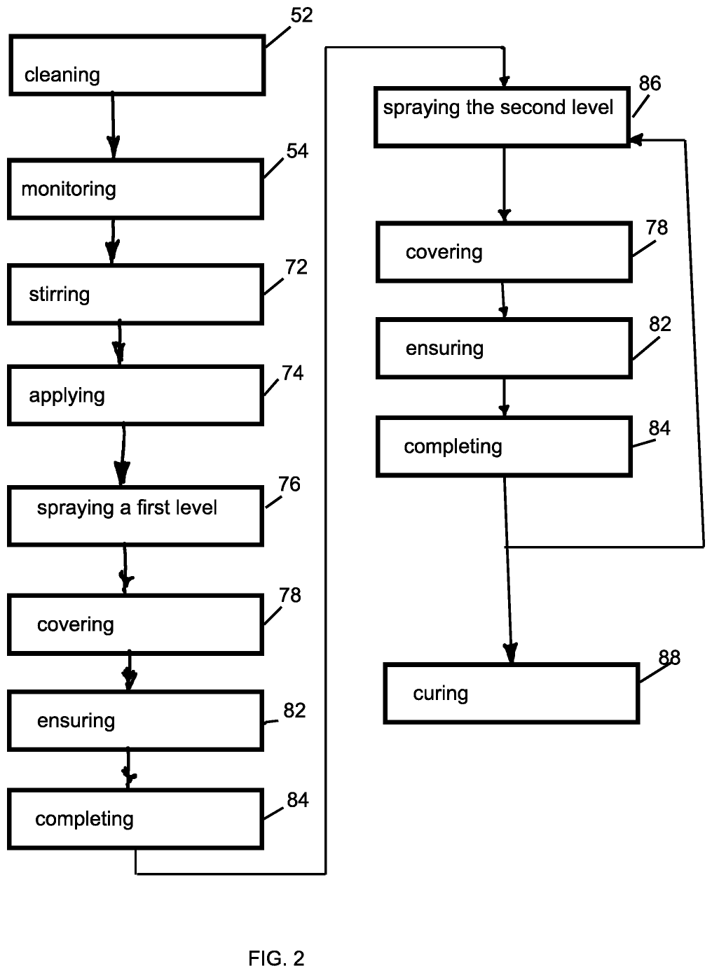

Referring to the drawings wherein identical reference numerals denote the same elements throughout the various views, the disclosed technology provides a method for applying a protective coating to a roofing material. As illustrated in FIGS. 1 and 2, the roofing material is preferably installed on a roof 10 according to conventional methods. Subsequently, a protective coating is applied to the roof in accordance with the method below. According to an alternative embodiment, a protective coating can be applied to individual tiles or sheets of roof material such as asphalt shingles, and then the asphalt shingles can be applied to the roof 10.

As shown, the roof 10 extends from a first point 12 to a second point 14.

According to the illustrated embodiment, the first point 12 is higher than the second point 14. It should be appreciated that in some embodiments the roof is substantially level and flat such that the first point 12 and the second point 14 are essentially at the same level.

The roof 10 includes a substrate layer 22. In the preferred embodiment, the substrate layer 22 is plywood. Positioned on the substrate layer 22 is an intermediate layer 24. In the preferred embodiment, the intermediate layer 24 is felt paper. Positioned on the intermediate layer 24 is the asphalt single layer 26 which defines the roof surface 28. Positioned on the asphalt shingle layer 26 is the coating layer 30.

As will be discussed below, the coating layer 30 is applied in a series of rows. The series of rows are indicated with reference numbers 32, 34, 42, 44, 46, and 48. According to the preferred embodiment, adjacent rows of the coating layer 30 overlap in overlap regions 36.

A spraying means is provided to apply the protective coating. In the preferred embodiment, the spraying means is an airless low-pressure system. The spraying means includes, for example, a system utilizing a commercial powered pump sprayer with a fan nozzle. In other embodiments, other spraying means known to one of ordinary skill in the art can be used including, without limitation, manual hand pumps and powered pumping systems. These systems can be backpack mounted or freestanding. Preferably, spraying means with low pressure are utilized. In this regard, spray pressures of about 276 kPa (40 psi) to about 345 kPa (50 psi) are preferred. It should be appreciated that the protective coating can be applied with a roller or brush as necessary to complete the desired coverage.

The protective coating can be any concrete sealant. In the preferred embodiment, the concrete sealant is one such as the commercially available ChemMasters Polyseal water-based curing and sealing compound. The protective sealant includes between about 70% and about 75% water, about 25% acrylic polymer, between about 1% and about 3% trimethylpentanediol monoisobutyrate, no more than 0.5% tetrahydro-1,4-oxazine, and no more than about 0.1% S Triazine 1,2,4 (2H,4H,6H) triethanol. Preferably, the coating is substantially clear.

Referring now to FIG. 2, according to the preferred embodiment of the disclosed technology, the method of applying a protective sealant to any roof type (including pitched roofs of various slopes and flat roofs) includes the steps described below. These steps are grouped into two phases. In a first phase 50, cleaning and surface preparation is conducted. In a second phase 70, the protective coating is prepared and applied.

The first phase 50 includes the following steps. In a cleaning step 52, the roof surface 28 is cleaned to remove any contaminants including, without limitation, dirt, mud, debris, sap, and plants, such as moss and algae, from the exterior roof surface. In a monitoring step 54, the environmental air temperature is monitored to determine whether the environmental air temperature is within an acceptable predetermined range. According to the preferred embodiment, the environmental air temperature is preferably between about 13° C. (55° F.) and about 66° C. (150° F.); and more preferably between about 16° C. (60° F.) and about 38° C. (100° F.). In a drying step 56, the roof surface is allowed to dry such that it is free of water or other liquids before the application of the protective coating begins.

The roof surface 28 must be maintained free of water or other liquid during both the application and the curing periods. In the preferred embodiment, there is no precipitation during the curing period.

The second phase 70 addresses the preparation of the protective coating and its application. The second phase 70 includes the following steps. In a stirring step 72, the sealant is gently stirred or agitated prior to use. In an applying step 74, beginning at the first point 12, the highest part of the roof in the illustrated embodiment, the protective coating is sprayed and applied. application is continued from the first point 12 to the second point 14 in generally parallel rows 32, 34, 42, 44, 46, and 48. The parallel rows can vary in width from between about 2 inches to approximately about 18 inches or more in width.

The applying step 74 includes the following sub steps. In a spraying a first row step 76, the coating is sprayed horizontally at the first initial row. As shown, the first row in this case is the horizontal row 32. In a covering step 78, the roof surface is covered with the protective coating generally uniformly. In an ensuring step 82, the protective coating is ensured to fully penetrate and cover cracks and crevices within the roof surface 28.

In a completing step 84, as the first row is completed, it is determined whether more roof surface 28 to be coated exists adjacent to it. If so, the operator continues to a second row that is adjacent the first row. In a spraying the second row step 86, an operator applying the protective coating positions themselves away from the area to be coated, i.e. a working area. In the illustrated example where the roof is sloped, the operator positions themselves below the working area of roof to which the protective coating is applied. The operator selects the second row on which to spray which is adjacent to and overlaps the first row. In the illustrated embodiment, the second row is defined by row 34. The covering step 78 and the ensuring step 82 are also performed in the spraying the second row step 86.

Once it is completely covered, the second row becomes the first row for the next row of uncovered roof 28 below it. In this example, the next horizontal row of uncovered roof 28 is row 36. The spraying the second row step 86 is repeated to coat the row 36. Then the spraying the second row step 86 is repeated until the roof surface 28 is covered. In the illustrated embodiment, the spraying the second row step 86 is repeated until row 48 has been covered. Throughout the process, the operator continues to remain outside of the working area, careful not to walk on or otherwise make contact with the applied but uncured protective sealant.

During application, the protective coating is applied uniformly across the entire roof surface 28. The rows of protective coating may overlap in overlap regions 36 to provide adequate coverage on the roof surface to avoid leaving gaps or pinholes. Also, care must be taken to fill in existing cracks and crevices within the roof surface. The protective coating must be applied evenly and not allowed to puddle or unevenly flow down the sloping surfaces.

In a curing step 88, the protective coating is allowed to cure for a predetermined period of time after the applying step is complete. According to the preferred embodiment, the curing period is at least one hour. In other embodiments, the curing period can be shorter than one hour or as long as seven days. The curing period will vary depending upon the roof temperature, the specific coating material chosen, and the thickness of the coating material applied.

Once fully cured, successive coats may be applied to further increase protection, if desired, using the second phase of the method as described above.

According to an alternative embodiment, the protective coating sealant can be tinted to provide a desired color.

In other embodiments, the protective coating can be of any material known to one of ordinary skill in the art of concrete or asphalt sealing including, without limitation, any and all combinations of different coating materials.

The foregoing has described a method and protective coating for protecting roofs. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A method for providing a protective coating to a roof surface, the method including the steps of:
providing a spraying means and a liquid protective coating, the spraying means being configured to apply the protective coating;
operating the spraying means such that the protective coating is applied to the roof surface beginning at a first row;
applying the protective coating by performing the following steps;
spraying the first row;
covering the roof surface with the protective coating generally uniformly;
completing the first row and continuing to a second row that is adjacent the first row;
repeating the applying step such that the second row becomes the first row until the roofing surface is covered; and
curing the protective coating for a predetermined period of time.

2. The method according to claim 1, wherein the roof is sloped such that the first row is generally above the second row.

3. The method according to claim 1, wherein the spraying means is a backpack mounted, sprayer.

4. The method according to claim 1, wherein the second row overlaps the first row.

5. The method according to claim 4, wherein the second row overlaps the first row about one inch.

6. The method according to claim 1, wherein the predetermined period of time for the curing step is 1 hour.

7. The method according to claim 1, wherein the predetermined period of time for the curing step is greater than one hour.

8. The method according to claim 1, wherein the predetermined period of time for the curing step is about seven days.

9. The method according to claim 1, further comprising the step of ensuring that the protective coating fully penetrates and covers cracks and crevices.

10. A method for providing a protective coating to a roof surface, the method including the steps of:
providing a spraying means and a liquid protective coating, the spraying means being an airless low-pressure system being configured to apply the protective coating;
operating the spraying means such that the protective coating is applied to the roof surface beginning at a first row that is at the highest point of the roof surface;
applying the protective coating by performing the following steps;
spraying horizontally at the first row;
covering the roof surface with the protective coating generally uniformly;
ensuring that the protective coating fully penetrates and covers cracks and crevices;
completing the first row and continuing to a second row that is below the first row;
repeating the applying step such that the second row becomes the first row until the roofing surface is covered; and
curing the protective coating for a predetermined period of time.

11. The method according to claim 10, wherein the spraying means is a backpack mounted, hand pumped sprayer.

12. The method according to claim 10, wherein the spraying means is a backpack mounted, powered pumped sprayer.

13. The method according to claim 10, wherein the second row overlaps the first row.

14. The method according to claim 13, wherein the second row overlaps the first row about one inch.

15. The method according to claim 10, wherein the predetermined period of time for the curing step is 1 hour.

16. The method according to claim 10, wherein the predetermined period of time for the curing step is greater than one hour.

17. The method according to claim 10, wherein the predetermined period of time for the curing step is about seven days.

18. A method for providing a protective coating to a roof surface, the method including the steps of:
providing the roof surface, a spraying means, and a liquid protective coating, the roof surface configured to include a substrate layer, a support layer and a roofing material layer the spraying means being configured to apply the protective coating;
operating the spraying means such that the protective coating is applied to the roof surface beginning at a first row;
applying the protective coating by performing the following steps;
spraying horizontally at the first row;
covering the roof surface with the protective coating generally uniformly;
completing the first row and continuing to a second row that is below the first row;
repeating the applying step such that the second row becomes the first row until the roofing surface is covered; and
curing the protective coating for a predetermined period of time.

19. The method according to claim 18, wherein the roofing material layer is comprised of asphalt shingles.

20. The method according to claim 18, wherein the spraying means is an airless low-pressure system.
